(19) United States
(12) Patent Application Publication
(10) Pub. No.: US 2020/0028161 A1
(43) Pub. Date: Jan. 23, 2020

(54) LITHIUM ION BATTERY FOR VEHICLES AND METHOD FOR MANUFACTURING THE SAME

(71) Applicants: Hyundai Motor Company, Seoul (KR); Kia Motors Corporation, Seoul (KR); The Industry & Academic Cooperation in Chungnam National University, Daejeon (KR)

(72) Inventors: Jae Min LIM, Suwon-si (KR); Ju Yeong SEONG, Hwaseong-si (KR); Yong Jun JANG, Seongnam-si (KR); Jong Heon KIM, Daejeon (KR); Chun Joong KIM, Daejeon (KR); Hyun Suk KIM, Daejeon (KR)

(73) Assignees: Hyundai Motor Company, Seoul (KR); Kia Motors Corporation, Seoul (KR); The Industry & Academic Cooperation in Chungnam National University, Daejeon (KR)

(21) Appl. No.: 16/206,597

(22) Filed: Nov. 30, 2018

(30) Foreign Application Priority Data
Jul. 18, 2018 (KR) 10-2018-0083206

(51) Int. Cl. H01M 4/36; H01M 10/0525; H01M 4/505; H01M 4/58; H01M 4/525; H01M 4/62; H01M 10/0585

(52) U.S. Cl. CPC H01M 4/366; H01M 10/0525; H01M 4/505; H01M 4/5825; H01M 2004/028; H01M 4/628; H01M 10/0585; H01M 2220/20; H01M 4/525

(57) ABSTRACT

A lithium ion battery for vehicles is provided. The battery includes a substrate, a positive electrode auxiliary layer disposed on the substrate and including at least one of platinum, gold, palladium, silver or combinations thereof, a positive electrode disposed on the positive electrode auxiliary layer and including an active material selected from at least one of LiNi_{0.5}Mn_{1.5}O₄, LiCoPO₄, LiMnPO₄, or combinations thereof, an electrolyte layer disposed on the positive electrode, and a negative electrode disposed on the electrolyte layer.

### CROSS-REFERENCE TO RELATED APPLICATION

The present application claims priority to and the benefit of Korean Patent Application No. 10-2018-0083206 filed on Jul. 18, 2018, which is incorporated herein by reference in its entirety.

### TECHNICAL FIELD

The present disclosure relates to a lithium ion battery for vehicles and a method for manufacturing the same and more particularly, to a lithium ion battery for vehicles that is suitable as an energy source for vehicles due to high power and a method for manufacturing the same.

### BACKGROUND

The statements in this section merely provide background information related to the present disclosure and may not constitute prior art.

Lithium ion batteries have attracted a great deal of attention as next-generation energy sources for vehicles. There is a need for development of lithium ion batteries with high power in order to use lithium ion batteries as energy sources for vehicles.

Chemical of Material, 2016 28(8), pp 2634-2640 discloses a positive electrode for high voltage applications for producing lithium ion batteries capable of providing high power. When a positive electrode is produced from a powder of LiNi_{0.5}Mn_{1.5}O₄ disclosed in the aforementioned document, there is a problem that battery capacities are not provided. To provide battery capacities, it is necessary to coat the surface of LiNi_{0.5}Mn_{1.5}O₄ powder or to use an electrolyte with a high ion-conductivity of 2.0×10⁻² S/cm or more. This case provides a low capacity of about 80 mAh/g @ 1 cycle as well.

### SUMMARY

It is one aspect of the present disclosure to provide a lithium ion battery for vehicles including a positive electrode for high-voltage applications.

It is another aspect of the present disclosure to provide a method for manufacturing a lithium ion battery for vehicles including a positive electrode for high-voltage applications.

In one aspect, the present disclosure provides a lithium ion battery for vehicles including a substrate, a positive electrode auxiliary layer disposed on the substrate and including one or more of platinum, gold, palladium, silver and combinations thereof, a positive electrode disposed on the positive electrode auxiliary layer and including an active material selected from the group consisting of LiNi_{0.5}Mn_{1.5}O₄, LiCoPO₄, LiMnPO₄, and combinations thereof, an electrolyte layer disposed on the positive electrode, and a negative electrode disposed on the electrolyte layer.

A thickness of the positive electrode auxiliary layer may be smaller than a thickness of the positive electrode.

A thickness of the positive electrode auxiliary layer may be 100 to 500 nm.

The lithium ion battery for vehicles may further include an adhesive layer disposed between the substrate and the positive electrode auxiliary layer.

The adhesive layer may include one or more of Ti, Al, Cu and combinations thereof.

The positive electrode may be active at a voltage of 4.0 to 10.0V.

The substrate may include stainless steel.

The positive electrode auxiliary layer may suppress diffusion of iron contained in the substrate to the positive electrode.

In another aspect, the present disclosure provides a method for manufacturing a lithium ion battery for vehicles including providing a substrate, providing, on the substrate, a positive electrode auxiliary layer including one or more of platinum, gold, palladium, silver and combinations thereof, providing a positive electrode on the positive electrode auxiliary layer, providing an electrolyte layer on the positive electrode and providing a negative electrode on the electrolyte layer.

The providing a positive electrode auxiliary layer may include depositing one or more of platinum, gold, palladium, silver and combinations thereof on the substrate.

The providing a positive electrode may include sputtering an active material selected from the group consisting of LiNi_{0.5}Mn_{1.5}O₄, LiCoPO₄, LiMnPO₄, and combinations thereof.

A thickness of the positive electrode auxiliary layer may be smaller than a thickness of the positive electrode.

In the providing a positive electrode auxiliary layer, a thickness of the positive electrode auxiliary layer may be 100 to 500 nm.

The method may further include providing an adhesive layer between the substrate and the positive electrode auxiliary layer.

In the providing a substrate, the substrate may include stainless steel.

Other aspects and preferred forms of the disclosure are discussed infra.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a schematic sectional view illustrating a lithium ion battery for vehicles in one form of the present disclosure;

FIG. 1B is a schematic sectional view illustrating a lithium ion battery for vehicles in one form of the present disclosure;

FIG. 2 is a schematic flowchart illustrating a method for manufacturing a lithium ion battery for vehicles in one form of the present disclosure;

FIG. 3A is a current potential curve of a lithium ion battery according to Example 1 measured by cyclic voltammetry;

FIG. 3B is a current potential curve of a lithium ion battery according to Comparative Example 1 measured by cyclic voltammetry;

FIG. 4A shows charge/discharge testing results of the lithium ion battery according to Example 1;

FIG. 4B shows charge/discharge testing results of the lithium ion battery according to Comparative Example 1;

FIG. 5A shows results of depth profile analysis using X-ray photoelectron spectroscopy (XPS) of the lithium ion battery according to Example 1; and

FIG. 5B shows results of depth profile analysis using X-ray photoelectron spectroscopy (XPS) of the lithium ion battery according to Comparative Example 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Like reference numbers refer to like elements throughout the description of the figures. In the drawings, the sizes of structures are exaggerated for clarity. It will be understood that, although the terms “first”, “second”, etc. may be used herein to describe various elements, these elements should not be limited by these terms and are used only to distinguish one element from another. For example, within the scope defined by the present disclosure, a first element may be referred to as a second element and, similarly, a second element may be referred to as a first element. Singular forms are intended to include plural forms as well, unless context clearly indicates otherwise.

It will be further understood that the terms “comprises” and/or “has”, when used in this specification, specify the presence of stated features, numbers, steps, operations, elements, components or combinations thereof, but do not preclude the presence or addition of one or more other features, numbers, steps, operations, elements, components, or combinations thereof. In addition, it will be understood that, when an element such as a layer, film, region or substrate is referred to as being “on” another element, it can be directly on the other element or an intervening element may also be present. It will also be understood that when an element such as a layer, film, region or substrate is referred to as being “under” another element, it can be directly under the other element or an intervening element may also be present.

Hereinafter, the lithium ion battery for vehicles in one form of the present disclosure will be described below.

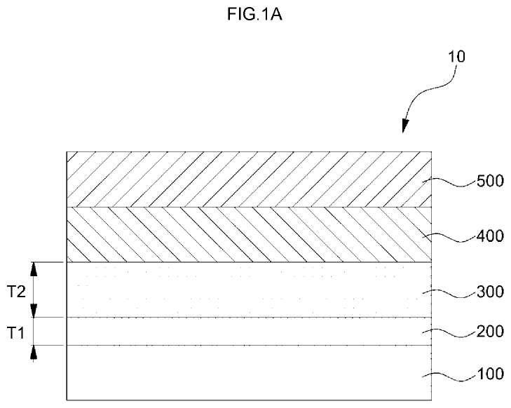

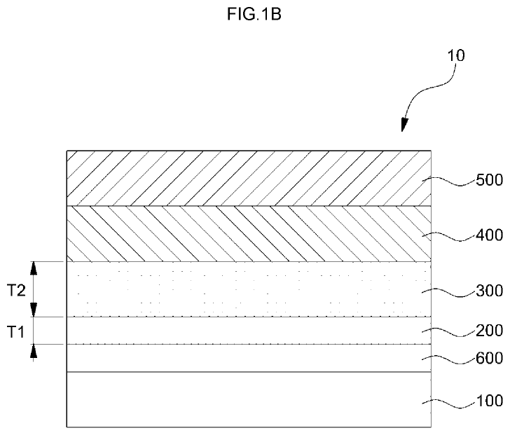

FIG. 1A is a schematic sectional view illustrating a lithium ion battery for vehicles in one form of the present disclosure.

Referring to FIG. 1A, the lithium ion battery 10 for vehicles in one form of the present disclosure may be used as an energy source for vehicles. The vehicle may be a means used to transport an object, a person or the like. The vehicle may be, for example, a land vehicle, a marine vessel or an aircraft. Examples of the land vehicle may include cars including passenger cars, vans, trucks, trailer trucks and sports cars, bicycles, motorcycles, trains and the like. Examples of the marine vessel may include ships and submarines. Examples of the aircraft may include airplanes, hang gliders, hot air balloons, helicopters and small aircraft such as drones.

The lithium ion battery 10 for vehicles in some forms of the present disclosure undergoes electrochemical reaction by charge/discharge. Upon charge, lithium is split into a lithium ion and an electron at a positive electrode 300. The lithium ion is moved to a negative electrode 500 via an electrolyte layer 400. The electron can be moved to the negative electrode 500, for example, through an exterior circuit. At the negative electrode 500, oxygen molecules, lithium ions and electrons react together to produce electric energy and thermal energy. Upon discharge, lithium ions are discharged from the negative electrode 500 and are moved to the positive electrode 300 through an electrolyte layer 400. The electrons are, for example, moved through the exterior circuit to the positive electrode 300.

The lithium ion battery 10 for vehicles in some forms of the present disclosure includes a substrate 100, a positive electrode auxiliary layer 200, a positive electrode 300, an electrolyte layer 400 and a negative electrode 500.

The substrate 100 can protect the positive electrode 300, the electrolyte layer 400 and the negative electrode 500 from external impact.

The substrate 100 functions as a current collector to transfer electrons generated during electrochemical reaction to an exterior load, in addition to the function to protect electrodes.

The substrate 100 may, for example, include stainless steel.

FIG. 1B is a schematic sectional view illustrating a lithium ion battery for vehicles in one form of the present disclosure.

Referring to FIG. 1B, the lithium ion battery for vehicles in some forms of the present disclosure further includes an adhesive layer. The adhesive layer is interposed between the substrate and the positive electrode auxiliary layer. The adhesive layer prevents the substrate and the positive electrode auxiliary layer from being spaced apart from each other. The adhesive layer, for example, includes one or more of Ti, Al, Cu and combinations thereof.

Referring to FIGS. 1A and 1B, the positive electrode auxiliary layer 200 can suppress diffusion of iron contained in the substrate 100 into the positive electrode 300. The positive electrode auxiliary layer 200 is disposed on the substrate 100. The positive electrode auxiliary layer 200 includes one or more of platinum, gold, palladium, silver and combinations thereof. Preferably, the positive electrode auxiliary layer 200 includes platinum.

The thickness t1 of the positive electrode auxiliary layer 200 may be less than the thickness t2 of the positive electrode 300. When the thickness t1 of the positive electrode auxiliary layer 200 is greater than or equal to the thickness t2 of the positive electrode 300, it may be difficult to suppress diffusion of iron into the positive electrode 300.

The thickness t1 of the positive electrode auxiliary layer 200 may be 100 to 500 nanometers (nm). When the thickness t1 of the positive electrode auxiliary layer 200 is less than 100 nm, the diffusion of iron contained in the substrate 100 into the positive electrode 300 cannot be sufficiently suppressed and, when the thickness t1 of the positive electrode auxiliary layer 200 is higher than 500 nm, weight reduction of batteries is impossible.

The positive electrode 300 is disposed on the positive electrode auxiliary layer 200. The positive electrode 300 includes an active material selected from the group consisting of LiNi_{0.5}Mn_{1.5}O₄, LiCoPO₄, LiMnPO₄, and combinations thereof. The positive electrode 300 may be a positive electrode for high-voltage applications. Generally provided positive electrodes are for low-voltage (less than 4.5V) applications. The lithium ion battery for vehicles 10 in some forms of the present disclosure is for high-voltage applications and, for example, the positive electrode 300 can be activated (actively reacted) at a voltage of 4.5 to 10.0V.

The electrolyte layer 400 is disposed on the positive electrode 300. The electrolyte layer 400 includes, for example, LiPF₆. The electrolyte layer 400 includes, for example, an electrolyte such as ethylene carbonate (EC), diethyl carbonate (DEC) or polycarbonate (PC), and LiPF₆.

The negative electrode 500 is disposed on the electrolyte layer 400. The negative electrode 500 includes, for example, lithium.

A method for manufacturing a lithium ion battery for vehicles in some forms of the present disclosure includes providing the positive electrode auxiliary layer, thereby preventing diffusion of ions from the substrate to the positive electrode. Thus, the positive electrode is electrochemically active at a high voltage and lithium ion batteries can thus provide improved power and prolonged lifespan.

Hereinafter, a method for producing the lithium ion battery for vehicles in some forms of the present disclosure will be described. The following detailed disclosure will focus on the difference from the lithium ion battery for vehicles in some forms of the present disclosure described before and omitted contents conform to the description associated withthe lithium ion battery for vehicles in some forms of the present disclosure.

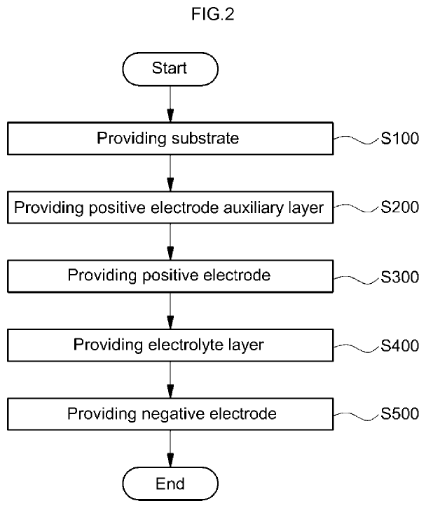

FIG. 2 is a schematic flowchart illustrating a method for manufacturing a lithium ion battery for vehicles in one form of the present disclosure.

Referring to FIGS. 1A, 1B and 2, the method for manufacturing the lithium ion battery for vehicles 10 in some forms of the present disclosure includes providing a substrate 100 (S100), providing, on the substrate 100, a positive electrode auxiliary layer 200 using one or more of platinum, gold, palladium, silver and combinations thereof (S200), providing a positive electrode 300 on the positive electrode auxiliary layer 200 (S300), providing an electrolyte layer 400 on the positive electrode 300 (S400) and providing a negative electrode 500 on the electrolyte layer 400 (S500).

In the providing a substrate 100 (S100), the substrate 100 may include stainless steel.

The method for manufacturing the lithium ion battery for vehicles 10 in some forms of the present disclosure may further include providing an adhesive layer 600 between the substrate 100 and the positive electrode auxiliary layer 200. The adhesive layer is interposed between the substrate and the positive electrode auxiliary layer. The adhesive layer prevents the substrate and the positive electrode auxiliary layer from being spaced from each other. The adhesive layer includes, for example, one or more of Ti, Al, Cu and combinations thereof.

The positive electrode auxiliary layer 200 is disposed on the substrate 100 (S200). The provision of the positive electrode auxiliary layer 200 (S200) can be carried out by depositing one or more of platinum, gold, palladium, silver and combinations thereof on the substrate 100. Preferably, the positive electrode auxiliary layer 200 can be formed by depositing platinum on the substrate 100. Thus, diffusion of ions from the substrate 100 to the positive electrode 300 can be suppressed.

In the provision of the positive electrode auxiliary layer 200 (S200), the thickness t1 of the positive electrode auxiliary layer 200 may be less than the thickness t2 of the positive electrode 300. When the thickness t1 of the positive electrode auxiliary layer 200 is greater than or equal to the thickness t2 of the positive electrode 300, it may difficult to suppress diffusion of iron into the positive electrode 300.

In the provision of the positive electrode auxiliary layer 200 (S200), the thickness t1 of the positive electrode auxiliary layer 200 may be 100 to 500 nanometers (nm). When the thickness t1 of the positive electrode auxiliary layer 200 is less than 100 nm, diffusion of iron contained in the substrate 100 into the positive electrode 300 cannot be sufficiently suppressed and, when the thickness t1 of the positive electrode auxiliary layer 200 is higher than 500 nm, weight reduction of batteries is impossible.

The positive electrode 300 is disposed on the positive electrode auxiliary layer 200 (S300). The provision of the positive electrode 300 (S300) may be carried out by sputtering an active material selected from the group consisting of LiNi_{0.5}Mn_{1.5}O₄, LiCoPO₄, LiMnPO₄, and combinations thereof.

The electrolyte layer 400 is disposed on the positive electrode 300 (S400). The electrolyte layer 400 includes, for example, LiPF₆. The electrolyte layer 400 includes, for example, an electrolyte such as ethylene carbonate (EC), diethyl carbonate (DEC) or polycarbonate (PC), and LiPF₆.

The negative electrode 500 is formed on the electrolyte layer 400 (S500). The negative electrode 500 includes, for example, lithium.

The method for manufacturing a lithium ion battery for vehicles in some forms of the present disclosure includes providing the positive electrode auxiliary layer, thereby preventing diffusion of ions from the substrate to the positive electrode. Thus, the positive electrode is electrochemically active at a high voltage and lithium ion batteries can thus provide improved power and prolonged lifespan.

Hereinafter, the present disclosure will be described in more detail with reference to specific examples. However, the examples are provided only for illustration of the present disclosure and should not be construed as limiting the scope of the present disclosure.

### Example 1

A substrate with a thickness of about 1 mm was formed using stainless steel. Platinum was deposited on the substrate to form a positive electrode auxiliary layer with a thickness of about 100 nm. LiNi_{0.5}Mn_{1.5}O₄ was sputtered on the positive electrode auxiliary layer to form a positive electrode with a thickness of about 400 nm. An electrolyte layer with a thickness of 20 μm was formed on the positive electrode using 1M LiPF₆ in EC:DEC. A lithium negative electrode was formed on the electrolyte layer to produce a lithium ion battery.

### Comparative Example 1

A lithium ion battery was produced in the same manner as in Example 1 except that the positive electrode auxiliary layer was not formed.

### Test Example 1—Current Potential Curve Measured by Cyclic Voltammetry

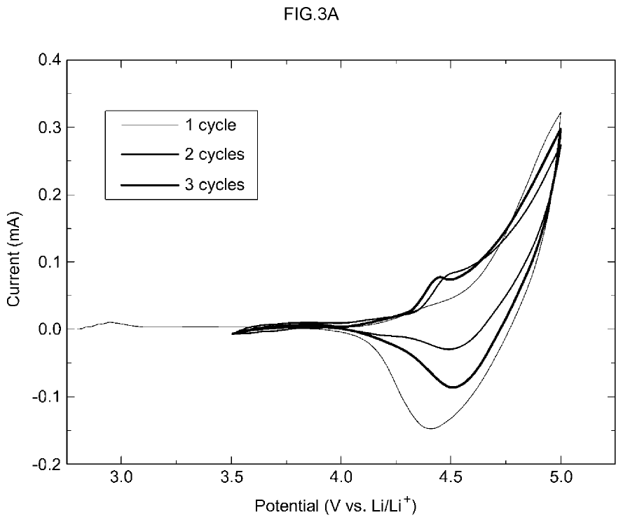

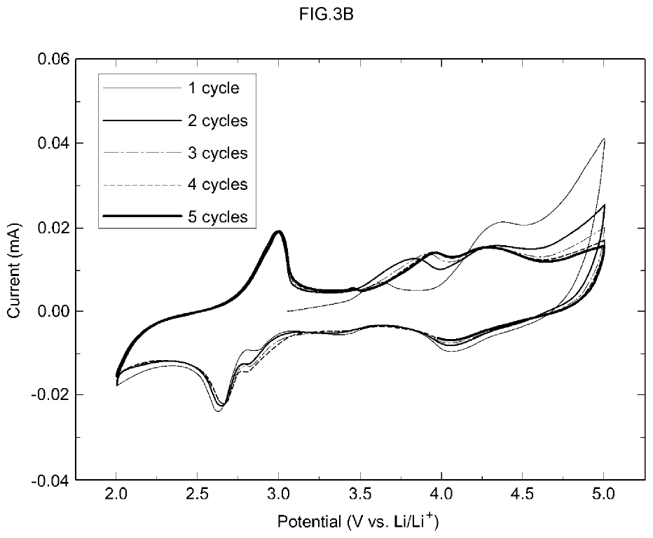

The current potential curve of the lithium ion battery according to Example 1 was measured under 3.5 to 5V and 1 mV/s conditions by cyclic voltammetry and is shown in FIG. 3A.

The current potential curve of the lithium ion battery according to Comparative Example 1 was measured under 2 to 5V and 1 mV/s conditions by cyclic voltammetry and is shown in FIG. 3B.

Referring to FIG. 3B, the lithium ion battery according to Comparative Example 1 has oxidation and reduction behaviors of a high-manganese spinel or layer material (Li₄Mn₅O₁₂ or LiMn₂O₄) at a low voltage (3.25V or less) and at a high voltage (4.0V or more) due to mutual diffusion between the positive electrode and the substrate.

On the other hand, referring to FIG. 3A, the lithium ion battery according to Example 1 does not induce mutual diffusion between the positive electrode and the substrate and thus has only oxidation and reduction behaviors of an active material (LiNi_{0.5}Mn_{1.5}O₄), without oxidation and reduction behaviors of a high-manganese spinel or layer material. In addition, the lithium ion battery according to Example 1 is active at a higher voltage (4.5V or more), as compared to Comparative Example 1.

### Test Example 2—Charge/Discharge Testing

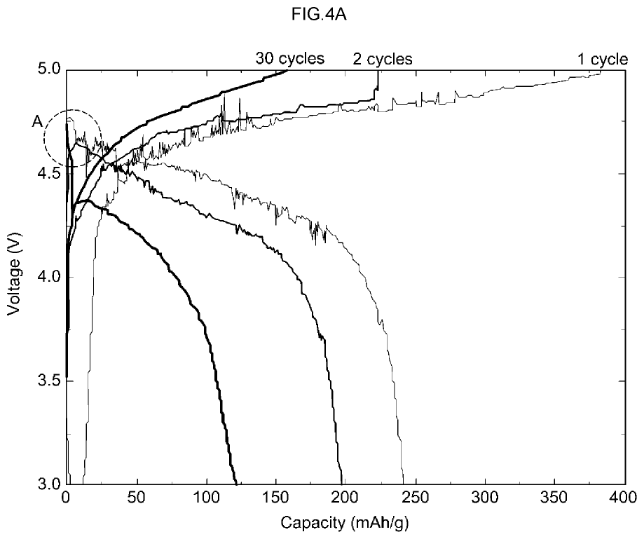

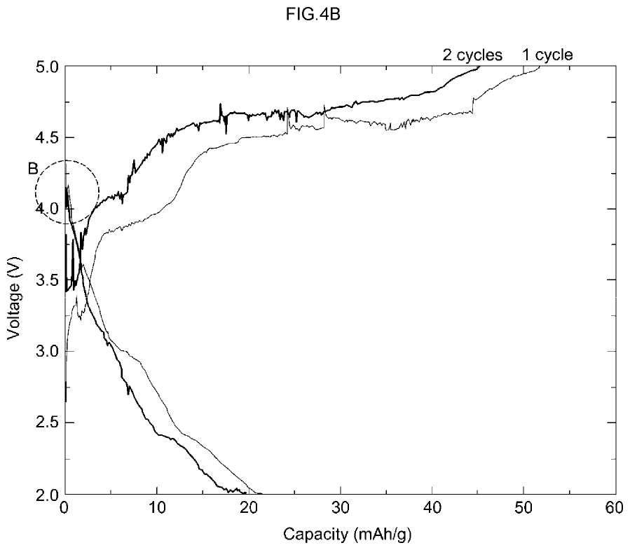

The lithium ion batteries of Example 1 and Comparative Example 1 were subjected to charge/discharge testing. FIG. 4A shows results of Example 1. FIG. 4B shows results of Comparative Example 1.

Referring to FIG. 4B, as can be seen from area B, the discharge voltage is slightly low, i.e., less than 4.5V and the number of charge/discharge cycles is about two.

Referring to FIG. 4A, as can be seen from area A, discharge voltage is high, i.e., 4.5V or more, charge/discharge curve is measured even after about 30 charge/discharge cycles and lifespan of batteries is lengthened.

### Test Example 3—Depth Profile Analysis Using X-Ray Photoelectron Spectroscopy (XPS)

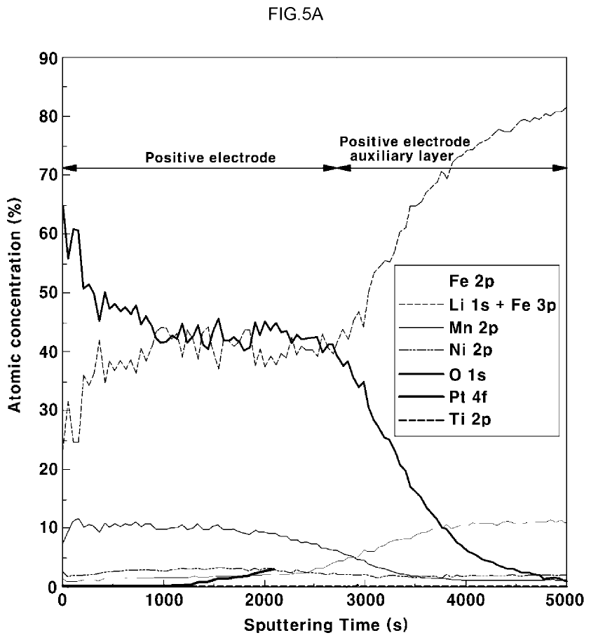

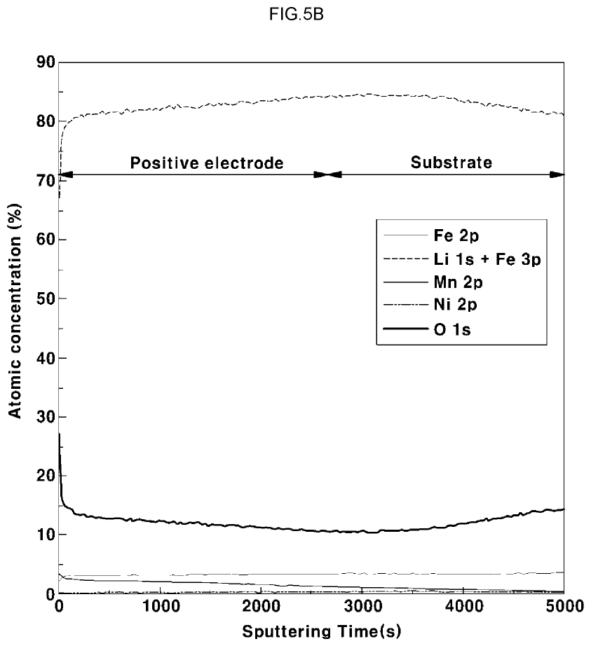

The depth profiles of lithium ion batteries according to Example 1 and Comparative Example 1 were analyzed with a photoelectron spectroscope. FIG. 5A shows results of Example 1. FIG. 5B shows results of Comparative Example 1.

Referring to FIG. 5A, it can be seen from Example 1 that the peak of Fe 3p+Li is has a lower atom concentration at the positive electrode. Referring to FIG. 5B, it can be seen from Comparative Example 1 that the peak of Fe 3p+Li 1s has a high atom concentration at the positive electrode and the substrate. That is, it can be seen from Example 1 that diffusion of the iron to the substrate from the positive electrode is suppressed by the positive electrode auxiliary layer.

As apparent from the foregoing, the lithium ion battery for vehicles in some forms of the present disclosure includes a positive electrode suitable for high-voltage applications, thereby providing improved power.

The method for manufacturing a lithium ion battery for vehicles in some forms of the present disclosure can provide a lithium ion battery which includes a positive electrode suitable for high-voltage applications and thereby can provide improved power.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A lithium ion battery for vehicles comprising:
a substrate;
a positive electrode auxiliary layer disposed on the substrate, the positive electrode auxiliary layer comprising at least one of platinum, gold, palladium, silver or combinations thereof;
a positive electrode disposed on the positive electrode auxiliary layer, the positive electrode comprising an active material selected from at least one of LiNi_{0.5}Mn_{1.5}O₄, LiCoPO₄, LiMnPO₄, or combinations thereof;
an electrolyte layer disposed on the positive electrode; and
a negative electrode disposed on the electrolyte layer.

2. The lithium ion battery for vehicles of claim 1, wherein a thickness of the positive electrode auxiliary layer is less than a thickness of the positive electrode.

3. The lithium ion battery for vehicles of claim 1, wherein the thickness of the positive electrode auxiliary layer is 100 to 500 nm.

4. The lithium ion battery for vehicles of claim 1, wherein the battery further comprises:
an adhesive layer disposed between the substrate and the positive electrode auxiliary layer.

5. The lithium ion battery for vehicles of claim 4, wherein the adhesive layer comprises at least one of Ti, Al, Cu or combinations thereof.

6. The lithium ion battery for vehicles of claim 1, wherein the positive electrode is active at a voltage of 4.0 to 10.0V.

7. The lithium ion battery for vehicles of claim 1, wherein the substrate comprises stainless steel.

8. The lithium ion battery for vehicles of claim 1, wherein the positive electrode auxiliary layer is configured to suppress diffusion of iron contained in the substrate to the positive electrode.

9. A method for manufacturing a lithium ion battery for vehicles comprising:
providing a substrate;
providing, on the substrate, a positive electrode auxiliary layer comprising at least one of platinum, gold, palladium, silver or combinations thereof;
providing a positive electrode on the positive electrode auxiliary layer;
providing an electrolyte layer on the positive electrode; and
providing a negative electrode on the electrolyte layer.

10. The method of claim 9, wherein providing the positive electrode auxiliary layer comprises depositing at least one of platinum, gold, palladium, silver or combinations thereof on the substrate.

11. The method of claim 9, wherein providing the positive electrode comprises sputtering an active material selected from at least one of LiNi_{0.5}Mn_{1.5}O₄,LiCoPO₄, LiMnPO₄, or combinations thereof.

12. The method of claim 9, wherein a thickness of the positive electrode auxiliary layer is less than a thickness of the positive electrode.

13. The method of claim 9, wherein the thickness of the positive electrode auxiliary layer is 100 to 500 nm.

14. The method of claim 9, wherein the method further comprises:
providing an adhesive layer between the substrate and the positive electrode auxiliary layer.

15. The method of claim 9, wherein the substrate comprises stainless steel.
